(19) United States
(12) Patent Application Publication
(10) Pub. No.: US 2022/0267496 A1
(43) Pub. Date: Aug. 25, 2022

(54) POLYPROPYLENE MODIFYING AGENT AND PREPARATION METHOD THEREFOR, POLYPROPYLENE COMPOSITION, AND POLYPROPYLENE MATERIAL AND PREPARATION METHOD THEREFOR

(71) Applicants: CHINA ENERGY INVESTMENT CORPORATION LIMITED, Beijing (CN); NATIONAL INSTITUTE OF CLEAN-AND-LOW-CARBON ENERGY, Beijing (CN)

(72) Inventors: Fang YU, Beijing (CN); WenBin LIANG, Beijing (CN); Yi MA, Beijing (CN); GuoGang LIU, Beijing (CN); ChunBo ZHANG, Beijing (CN)

(21) Appl. No.: 17/770,228

(22) PCT Filed: Apr. 9, 2020
(86) PCT No.: PCT/CN2020/083948

§ 371 Date: Apr. 19, 2022

(30) Foreign Application Priority Data
Oct. 21, 2019 (CN) 201911002015.0

(51) Int. Cl. C08F 255/02; C08L 23/12

(52) U.S. Cl. CPC C08F 255/023; C08L 23/12

(57) ABSTRACT

A polypropylene modifier and a preparation method therefor, polypropylene composition, and polypropylene material comprising the polypropylene modifier and a preparation method therefor are provided. The preparation method for the polypropylene modifier comprises: bringing a polar monomer grafted polypropylene into contact with a component A to carry out reactive extrusion and granulation, and then carrying out drying, wherein a polar monomer in the polar monomer grafted polypropylene is capable of chemically reacting with the component A; in formula (1), the polar monomer is selected from maleic anhydride, acrylic acid, and acrylate, etc; and the component A is selected from polyisocyanate, etc; and in formula (2), the polar monomer is selected from ditnethylaminoethyl methacrylate and epoxy acrylate, etc; and the component A is selected from polyisocyanate and polyethylene oxide, etc. When introduced into an ordinary linear polypropylene, the polypropylene modifier can significantly improve the melt strength and the mechanical properties of the polypropylene.

### CROSS-REFERERENCE TO RELATED APPLICATIONS

This application is a national stage of International Application No. PCT/CN2020/083948, filed on Apr. 9, 2020, which claims priority to Chinese Patent Application No. 201911002015.0, filed on Oct. 21, 2019, the contents of both of which are incorporated herein by reference in their entireties.

### TECHNICAL FIELD

The present invention relates to the field of polypropylene materials, and more particularly, to a preparation method for a polypropylene modifier and a polypropylene modifier prepared by the preparation method, polypropylene composition, and a preparation method for a polypropylene material and polypropylene material prepared by the method.

### BACKGROUND

Polypropylene is a general-purpose plastic, with the advantages of abundant raw material sources, low price, low density, high melting point, non-toxicity, chemical corrosion resistance, easy recovery, and easy degradation, The polypropylene has become an indispensable raw material for packaging, light industry, construction, electronics, electrical appliances, automobiles and other industries, and is one of the currently fastest growing thermoplastic resins. At present, most of the polypropylene sold in the market is a semi-crystalline linear polymer. Due to a soft long-chain macromolecular structure and a high crystallization tendency, the polypropylene has a softening point very close to a melting point. When the polypropylene reaches the crystalline melting point, the melt viscosity of the polypropylene can be reduced rapidly, and a large amount of crystallization heat is released during crystallization, so that the melt viscosity and melt strength of the polypropylene are further reduced. Therefore, the ordinary polypropylene has low melt strength, poor toughness, poor sag resistance, poor thermoformability, and poor foaming performance, which limits the application field of the polypropylene.

The high-melt-strength polypropylene may be applied in foaming, thermoforming, extrusion and coating, and other high-value-added fields, has a broader market application prospect, and has remarkable economic and social benefits in research and development. Therefore, it is a research hotspot of materials science in recent years to develop the high-melt-strength polypropylene. At present, methods for improving the melt strength of the polypropylene comprise initiation of polypropylene crosslinking, grafting modification, and blending modification with other resins.

The blending modification is a simple way to improve the melt strength of the ordinary polypropylene product. The ordinary polypropylene mainly has a linear structure, with each molecular structure comprising methyl, and is basically unbranched or uncrosslinked. By adding a polymer, an elastomer, or a low-melting-point copolymer having high melt strength, the melting point and the rigidity of the polypropylene can be reduced, thus obtaining good processability. CN105037952A, CN105153546A, CN104987588A, and JSP4940736 disclose such methods.

Linear PP may generate a long-branched chain by crosslinking modification, thus achieving the purpose of improving the melt strength. U.S. Pat. Nos. 5,047,446, 5,414,027, and 5,541,236 are all technologies of Himont Company for preparing the high-melt-strength polypropylene by irradiation crosslinking.

CN101125947A discloses a high-melt-strength polypropylene with a long-branched chain structure and a preparation method therefor. The preparation method for the high-melt-strength polypropylene with the long branched chain structure disclosed by the technology comprises the following steps of fully mixing a component A with an antioxidant and a heat stabilizer in a mixing kettle; then adding the mixture into a reactive double-screw extruder via a feeding port at a rate of 60 g/min to 200 g/min; adding an organic solution of a component B into the extruder via one side of the double-screw extruder; adding a supercritical carbon dioxide fluid into the extruder via the other side of the double-screw extruder, wherein a first heating zone of the double-screw extruder is at 180° C. to 220° C., and other heating zones of the double-screw extruder are at 140′C to 220° C.; and carrying out extrusion granulation to obtain a high-melt-strength polypropylene resin. The component A is a polar monomer melt grafted polypropylene polymer with a grafting ratio of greater than 0.3%, and the component B is an amine or alcohol compound. In this technology, amino or hydroxyl in the amine or alcohol compound reacts with the functional group on a polypropylene graft to generate a long-branched chain structure, thus achieving the purpose of improving the melt strength. In this technology, mechanical properties and a melt flow rate of a sample are measured, and measurement data of the melt strength is not given.

In addition, by blending the high-melt-strength polypropylene and the ordinary linear polypropylene in the prior art, the melt strength of the ordinary linear polypropylene can be improved to a certain extent, but the mechanical properties of the linear polypropylene can be reduced, which also limits the application of the modified polypropylene material. Therefore, there is an urgent need for a new polypropylene modifier which can not only improve the melt strength of the polypropylene, but also ensure the mechanical properties of the polypropylene.

### SUMMARY

The present invention aims to provide a polypropylene modifier and a preparation method and use therefor, a polypropylene composition, and a polypropylene material and preparation methods therefor. When introduced into an ordinary linear polypropylene, the polypropylene modifier can significantly improve the melt strength and the mechanical properties of the polypropylene.

According to a first aspect of the present invention, the present invention provides a preparation method for a polypropylene modifier, comprising: bringing a polar monomer grafted polypropylene into contact with a component A in formula (1) or formula (2) to carry out reactive extrusion and granulation, and then carrying out drying, wherein a polar monomer in the polar monomer grafted polypropylene is capable of chemically reacting with the component A;

in formula (1), the polar monomer is at least one of maleic anhydride, acrylic acid, acrylate, methacrylic acid, methacrylate, vinyl neodecanoate, glycidyl methacylate, dimethylaminoethyl methacrylate, epoxy acrylate, trimeric acrylic isocyanurate, and acrylamide; and the component A is at least one selected from polyisocyanate and polyethylene oxide;

in formula (2), the polar monomer is at least one selected from ditnethylaminoethyl methacrylate, epoxy acrylate, trimeric acrylic isocyanurate, and acrylamide; and the component A is at least one selected from polyisocyanate, polyethylene oxide, and an amine-containing substance, wherein the amine-containing substance is at least one selected from a compound I and a compound II, the compound I is an organic substance comprising an amine group, an ether bond, and an aryl group, and the compound II is polyamine; and

based on a total weight of the polar monomer grafted polypropylene and the component A in each formula, a content of the polar monomer grafted polypropylene ranges from 95 wt % to 99.8 wt %, and a content of the component A ranges from 0.2 wt % to 5 wt %.

According to a second aspect of the present invention, the present invention provides a polypropylene modifier prepared by the preparation method.

According to a third aspect of the present invention, the present invention provides polypropylene composition comprising the polypropylene modifier according to the present invention and polypropylene.

According to a fourth aspect of the present invention, the present invention provides a preparation method for polypropylene material, comprising: blending the polypropylene modifier according to the present invention and polypropylene at 180° C. to 220° C. to carry out extrusion granulation, and then carrying out drying.

According to a fifth aspect of the present invention, the present invention provides a polypropylene material prepared by the method according to the present invention.

The polypropylene modifier of the present invention may he used for modifying the polypropylene in a small amount by physical blending, and meanwhile, the melt strength and the mechanical properties of the polypropylene material are improved, and the components and the preparation process of the polypropylene material are simple and cost-effective.

Other features and advantages of the present invention will be described in detail in the following specific embodiments.

### EMBODIMENT

Specific embodiments of the present invention are described in detail hereinafter. It should be understood that the specific embodiments described herein are only used for describing and explaining the present invention, and are not intended to limit the present invention.

According to a first aspect of the present invention, the present invention provides a preparation method for a polypropylene modifier, comprising: bringing a polar monomer grafted polypropylene into contact with a component A in formula (1) or formula (2) to carry out reactive extrusion and granulation, and then carrying out drying.

In formula (1), a polar monomer in the polar monomer grafted polypropylene is at least one selected from maleic anhydride, acrylic acid, acrylate, methacrylic acid, methacrylate, vinyl neodecanoate, glycidyl methacylate, dimethylaminoethyl methacrylate, epoxy acrylate, trimeric acrylic isocyanurate, and acrylamide; and the component A is at least one selected from polyisocyanate and polyethylene oxide. When the selected polar monomer is used in combination with the selected component A, chemical reactions occur during the reactive extrusion.

Preferably, the acrylate is at least one selected from ethyl acrylate, butyl acrylate, and 2-ethylhexyl acrylate; and the methacrylate is at least one selected from ethyl methacrylate, propyl methacrylate, butyl methacrylate, and 2-hydroxyethyl methacrylate.

In formula (2), the polar monomer in the polar monomer grafted polypropylene is one or more selected from dimethylaminoethyl methacrylate, epoxy acrylate, trimeric acrylic isocyanurate, and acrylamide; and the component A is at least one selected from polyisocyanate, polyethylene oxide, and an amine-containing substance. When the selected polar monomer is used in combination with the selected component A, chemical reactions occur during the reactive extrusion.

In formula (2), in the case that the component A is the amine-containing substance, the component A and at least one polar monomer cooperate with each other, and just like formula (1), formula (2) may also achieve the effect of ensuring a high melt strength of the polypropylene and improving mechanical properties of the polypropylene.

According to the preparation method of the present invention, based on a total weight of the polar monomer grafted polypropylene and the component A in each formula, a content of the polar monomer grafted polypropylene ranges from 95 wt % to 99.8 wt %, and a content of the component A ranges from 0.2 wt % to 5 wt %.

Preferably, based on the total weight of the polar monomer grafted polypropylene and the component A in each formula, the content of the polar monomer grafted polypropylene ranges from 97 wt % to 99.5 wt %, and the content of the component A ranges from 0.5 wt % to 3 wt %.

According to the preparation method of the present invention, the polyisocyanate may be any polyisocyanate capable of chemically reacting with the polar monomer. Generally, the polyisocyanate is one or more selected from diphenylmethane diisocyanate, 2,4-tolylene diisocyanate, 2,6-tolylene diisocyanate, p-phenylene diisocyanate, hexamethylene diisocyanate, and 4,4,4-triphenylmethane triisocyanate(CAS No.: 25656-78-4). The diphenylmethane diisocyanate is preferably 4,4-diphenylmethane diisocyanate.

According to the preparation method of the present invention, a molecular weight of the polyethylene oxide ranges from 50×10⁴ g/mol to 200×10⁴ g/mol.

According to the preparation method of the present invention, the amine-containing substance is at least one selected from a compound I and a compound II, and preferably at least one of the compound I or at least one of the compound II. The compound I is an organic substance comprising an amine group, an ether bond, and an aryl group, and the compound H is polyamine. The compound I and the compound II are different.

According to a specific embodiment, the compound I is one or more of 4,4′-diaminodiphenyl ether, phenoxyaniline, 3,4′-dianiinodiphenyl ether, and 3,3′,4,4′-tetraaminodiphenyl ether, and is preferably phenoxyaniline and/or 3,3′,4,4′-tetraaminodiphenyl ether.

The compound II may he one or more of alkyl diamine, alkylene diamine, alkylene triamine, alkylene, tetramine, alkylene pentamine, and aryl diamine, such as one or more of C2-12 alkyl diamine, C2-12 alkylene diamine, C2-C12 alkylene triamine, C2-C12 alkylene tetramine, C2-C12 alkylene pentamine, and C6-C18 aryl diamine.

According to a specific embodiment, the compound II is one or more of tetraethylene pentamine, triethylene diamine, diethylene triamine, triethylene tetramine, p-phenylenediamine, m-phenylenediamine, 1,8-diaminooctane, 1,9-diaminononane, 1,10-decanediamine, and 1,12-diaminododecane; and is preferably diethylene triamine and/or 1,9-diaminononane.

In the present invention, the polar monomer grafted polypropylene (also known as poly propylene-grafted-polar monomer) may be obtained commercially, and may also be prepared by methods well known in the art, such as a solution grafting method, a melt grafting method, a solid-phase grafting method, and a radiation grafting method. According to one embodiment, the polar monomer grafted polypropylene is prepared by the melt grafting method comprising: mixing the polar monomer (1% to 10%), the polypropylene (90% to 99%), and the initiator (0.1% to 3%) evenly, then adding the resultant mixture into a double-screw extruder to carry out melt extrusion at an extruding temperature of 160° C. to 230° C., a rotating speed of 100 r/min to 400 r/min, and feeding rate of 5 Hz to 15 Hz, cooling a product through a basin and then granulating the product, and drying the product to obtain the polar monomer grafted polypropylene. The initiator may be at least one selected from benzoyl peroxide, lauroyl peroxide, di(tert-butylperoxyisopropyl)benzene, tert-butyl peroxybenzoate, diisopropyl peroxydicarbonate, and 2 5-dimethyl-2,5-di(tert-butyl peroxy)hexane.

According to one embodiment, a grafting ratio of the polar monomer grafted polypropylene ranges from 0.1 wt % to 3 wt %, and preferably ranges from 0.5 wt % to 2 wt %. A melt index (MI) of the polar monomer grafted polypropylene at 230° C. under 2.16 kg may range from 30 to 600 g/10 min, and preferably range from 45 to 350 g/10 min.

According to the preparation method of the present invention, the reactive extrusion method may be carried out according to a conventional operation, and for the present invention, a preferred reactive extrusion temperature ranges from 150° C. to 220° C. The extruder may have a rotating speed of such as 50 r/min to 100 r/min, and a feeding rate of such as 3 Hz to 8 Hz. The reactive extrusion may be carried out in various double-screw extruders. After extrusion granulation, the product may be dried at 80° C. to 95° C. for 30 minutes to 120 minutes.

According to a second aspect of the present invention, the present invention provides a polypropylene modifier prepared by the preparation method according to the first aspect of the present invention. The polypropylene modifier is capable of being physically blended with the ordinary polypropylene in a low proportion, which can not only ensure the high melt strength of the polypropylene, but also improve the mechanical properties of the polypropylene, thus broadening the application in thermoforming, extrusion and coating, and other high-value-added fields. Therefore, the present invention further provides polypropylene composition comprising the polypropylene modifier, and polypropylene material introduced with the polypropylene modifier and a preparation method therefor.

According to a third aspect of the present invention, the present invention provides polypropylene composition comprising the polymer modifier according to the present invention and polypropylene.

Preferably, based on a total weight of the polypropylene composition, a content of the polypropylene modifier ranges from 2% to 20%, and more preferably ranges from 5% to 10%.

According to a fourth aspect of the present invention, the present invention provides a preparation method for polypropylene material, comprising: blending the polypropylene modifier according to the present invention and polypropylene at 180° C. to 220° C. to carry out extrusion granulation, and then carrying out drying.

Preferably, based on a total weight of the polypropylene modifier and the polypropylene, a content of the polypropylene modifier ranges from 2% to 20%, and preferably ranges from 5% to 10%.

The polypropylene is not particularly limited in the present invention, and may be any existing linear polypropylene with the melt strength to be improved.

According to the method of the present invention, a blending extrusion condition may be a conventional choice in the art, and for the present invention, for example, the extruder has the rotating speed of 50 r/min to 100 r/min, and the feeding rate of 3 Hz to 5 Hz.

According to the method of the present invention, the drying is carried out at a temperature of 80° C. to 95° C. for 30 minutes to 120 minutes.

According to a fifth aspect of the present invention, the present invention provides a polypropylene material prepared by the method.

The present invention is further described with detailed exemplary embodiments hereinafter, but the present invention is not only limited to these Examples.

In the following Examples and Comparative Examples.

(1) Main Raw Materials

Maleic anhydride grafted polypropylene with a Grade of PO1020, purchased from ExxonMobil, with a grafting ratio of 1.2% and MI of 348 g/10 min;

Polyethylene oxide, with a molecular weight of 1,000,000 g/mol, purchased from Aladdin Reagent Corporation;

Polypropylene L5E89 which is ordinary linear polypropylene purchased from Baotou Coal Chemical Company of Shenhua. Coal-to-Oil. Chemical Co., Ltd.;

Polypropylene WB140, which is high-melt-strength polypropylene purchased from Borealis; and

PE100, with a Grade of 3490, purchased from Borealis.

(2) Property Test

Infrared spectroscopic analysis was carried out on a sample by Shimadzu IRPresidge-21 Fourier transform infrared spectrometer.

The melt strength of the polypropylene was tested by Rheotens 71.97 melt extension rheometer (Goettfert Company of Germany) at a measuring temperature of 200° C. A diameter of a die head was 2 mm, an initial rotating speed of a roller was 20 mm/s, an accelerated speed of the roller was 2.4 mm/s, and a distance from the die head to the roller was 65 mm.

Testing standards of the mechanical properties of the polypropylene material are as follows:

| Item | Unit | Testing standard |
|---|---|---|
| Tensile strength | MPa | ISO 527-1 |
| Bending strength | MPa | ISO 178/A |
| Bending modulus | MPa | ISO 178/A |

### EXAMPLE 1

(1) Preparation of Polypropylene Modifier

98.0 parts of methyl acrylate grafted polypropylene (with a grafting ratio of 1.0%, and MI of 52 g/10 min) were weighed, and fully mixed with 2.0 parts of polyethylene oxide. The fully mixed raw materials were added into a HAAKE double-screw extruder, wherein an extruding temperature was set as 190° C., a rotating speed of the extruder was 50 r/min, and a feeding rate was 3 Hz. After extrusion granulation, the obtained product was dried at 90° C. for 60 minutes to obtain the polypropylene modifier.

The polypropylene modifier was prepared into samples for infrared analysis. In an infrared is spectrogram, a characteristic absorption peak of carbonyl appeared at 1722 cm⁻¹, absorption peaks at 1145 cm⁻¹, 1118 cm^{-1,} and 1090 cm⁻¹ were symmetric and asymmetric stretching vibration peaks of a C—O—C group, and absorption peaks at 3000 cm⁻¹ to 2750 cm⁻¹ were asymmetric vibration absorption peaks of a —CH₂ group, which indicated that the methyl acrylate reacted with the polyethylene oxide, and the prepared product was the target product.

(2) Preparation of Polypropylene Material

10 parts of the polypropylene modifier and 90 parts of polypropylene L5E89 were evenly mixed, and then added into a HAAKE double-screw extruder for blending extrusion. An extruding temperature was set as 200° C., a rotating speed of the extruder was 100 r/min, and a feeding rate was 5 Hz. After granulation, the obtained product was dried at 90° C. for 60 minutes to obtain the polypropylene material.

Properties of the polypropylene material are shown in Table 1.

### COMPARATIVE EXAMPLE 1

A polypropylene modifier and a polypropylene material were prepared according to the methods in Example 1 except that, during preparation of the polypropylene modifier, the polyethylene oxide was replaced by 4,4′-diaminodiphenyl ether and tetraethylene pentamine in a mass ratio of 1:1.

Properties of the prepared polypropylene material are respectively shown in Table 1.

### EXAMPLE 2

(1) Preparation of Polypropylene Modifier

98.5 parts of acrylic acid grafted polypropylene (with a grafting ratio of 1.2 wt %, and MI of 67 g/10 min) were weighed, and fully mixed with 1.5 parts of 2,4-tolylene diisocyanate. The fully mixed raw materials were added into a HAAKE double-screw extruder, wherein an extruding temperature was set as 190° C., a rotating speed of the extruder was 50 r/min, and feeding rate was 3 Hz. After extrusion granulation, the obtained product was dried at 90° C. for 60 minutes to obtain the polypropylene modifier.

(2) Preparation of Polypropylene Material

10 parts of the polypropylene modifier and 90 parts of polypropylene L5E89 were evenly mixed, and then added into a HAAKE double-screw extruder for blending extrusion. An extruding temperature was set as 200° C., a rotating speed of the extruder was 100 r/min, and feeding rate was 5 Hz. After granulation, the obtained product was dried at 90° C. for 60 minutes to obtain the polypropylene material.

Properties of the polypropylene material are shown in Table 1.

### EXAMPLE 3

(1) Preparation of Polypropylene Modifier

99 parts of acrylamide grafted polypropylene (with a grafting ratio of 1.0 wt %, and MI of 64 g/10 min) were weighed, and fully mixed with 1 part of 4,4′-diphenylmethane diisocyanate. The fully mixed raw materials were added into a HAAKE double-screw extruder, wherein an extruding temperature was set as 180° C., a rotating speed of the extruder was 50 r/min, and feeding rate was 3 Hz. After extrusion granulation, the obtained product was dried at 90° C. for 30 minutes to obtain the polypropylene modifier.

The polypropylene modifier was prepared into samples for infrared analysis. In an infrared spectrogram, a stretching vibration peak of an N—H bond appeared at 3325 cm⁻¹, a characteristic absorption peak of a C—H bond in saturated alkane appeared at 2937 cm⁻¹, a stretching vibration peak of —C═O in an ester group occurred at 1670 cm⁻¹, and a deformation vibration peak occurred at 1560 cm⁻¹, which indicated that the acrylamide reacted with isocyanate, and the prepared product was the target product.

(2) Preparation of Polypropylene Material

5 parts of the polypropylene modifier and 95 parts of polypropylene L5E89 were evenly mixed, and then added into a HAAKE double-screw extruder for blending extrusion. An extruding temperature was set as 200° C., a rotating speed of the extruder was 100 r/min, and feeding rate was 5 Hz. After granulation, the obtained product was dried at 90° C. for 60 minutes to obtain the polypropylene material.

Properties of the polypropylene material are shown in Table 1.

### EXAMPLES 4 TO 6

A polypropylene modifier and a polypropylene material were prepared according to the methods in Example 3 except that, during preparation of the polypropylene modifier in Examples 4 to 6, the acrylamide grafted polypropylene was respectively replaced by maleic anhydride grafted polypropylene, dimethylaminoethyl methacrylate grafted polypropylene (with a grafting ratio of 1.8 wt %, and MI of 76 g/10 min) and epoxy acrylate grafted polypropylene (with a grafting ratio of 1.4wt %, and MI of 159 g/10 min, the epoxy acrylate grafted polypropylene used hereafter has the same parameters) in equal mass. Properties of the prepared polypropylene material are respectively shown in Table 1.

### EXAMPLE 7

A polypropylene modifier and a polypropylene material were prepared according to the methods in Example 3 except that, during preparation of the polypropylene modifier, the content of the acrylamide grafted polypropylene and the 4,4′-diphenylmethane diisocyanate were respectively adjusted to be 95 parts and 5 parts.

Properties of the prepared polypropylene material are respectively shown in Table 1.

### EXAMPLE 8

(1) Preparation of Polypropylene Modifier

99.3 parts of trimeric acrylic isocyanurate grafted polypropylene (with a grafting ratio of 1.6 wt %, and MI of 78 g/10 min) were weighed, and fully mixed with 0.7 part of phenoxyaniline. The fully mixed raw materials were added into a HAAKE double-screw extruder, wherein an extruding temperature was set as 200° C.′ a rotating speed of the extruder was 70 r/min, and feeding rate was 3 Hz. After extrusion granulation, the obtained product was dried at 90° C. for 70 minutes to obtain the polypropylene modifier.

The polypropylene modifier was prepared into samples for infrared analysis. In an infrared spectrogram, a stretching vibration characteristic peak of —C═O in urea appeared at 1660 cm⁻¹, a deformation vibration characteristic peak of —C═O in urea appeared at 1550 cm⁻¹, and a stretching vibration peak of —N—H in urea appeared at 3400 cm⁻¹, which indicated that an isocyanate group reacted with amino to generate urea, and the prepared product was the target product.

(2) Preparation of Polypropylene Material

5 parts of the polypropylene modifier and 95 parts of polypropylene L5E89 were evenly mixed, and then added into a HAAKE double-screw extruder for blending extrusion. An extruding temperature was set as 200° C., a rotating speed of the extruder was 100 r/min, and feeding rate was 5 Hz. After granulation, the obtained product was dried at 90° C. for 60 minutes to obtain the polypropylene material.

Properties of the polypropylene material are shown in Table 1.

### COMPARATIVE EXAMPLE 2

A polypropylene modifier and a polypropylene material were prepared according to the methods in Example 8 except that, during preparation of the polypropylene modifier, the trimeric acrylic isocyanurate grafted polypropylene was replaced by the maleic anhydride grafted polypropylene in an equal mass.

Properties of the prepared polypropylene material are shown in Table 1.

### COMPARATIVE EXAMPLE 3

(1) Preparation of Polypropylene Modifier

99.3 parts of maleic anhydride grafted polypropylene were weighed, and fully mixed with 0.4 part of phenoxyaniline and 0.3 part of p-phenylenediamine. The fully mixed raw materials were added into a HAAKE double-screw extruder, wherein an extruding temperature was set as 200° C., a rotating speed of the extruder was 70 r/min, and feeding rate was 3 Hz. After extrusion granulation, the obtained product was dried at 90° C. for 70 minutes to obtain the polypropylene modifier.

(2) Preparation of Polypropylene Material

5 parts of the polypropylene modifier and 95 parts of polypropylene L5E89 were evenly mixed, and then added into a HAAKE double-screw extruder for blending extrusion. An extruding temperature was set as 200° C., a rotating speed of the extruder was 100 r/min, and feeding rate was 5 Hz. After granulation, the obtained product was dried at 90° C. for 60 minutes to obtain the polypropylene material.

Properties of the polypropylene material are shown in Table 1.

### EXAMPLE 9

(1) Preparation of Polypropylene Modifier

98.3 parts of epoxy acrylate grafted polypropylene were weighed, and filly mixed with 1.7 parts of 1,9-diaminononane. The fully mixed raw materials were added into a HAAKE double-screw extruder, wherein an extruding temperature was set as 200° C., a rotating speed of the extruder was 100 r/min, and feeding rate was 5 Hz. After extrusion granulation, the obtained product was dried at 90° C. for 30 minutes to obtain the polypropylene modifier.

(2) Preparation of Polypropylene Material

6 parts of the polypropylene modifier and 94 parts of polypropylene L5E89 were evenly mixed, and then added into a HAAKE double-screw extruder for blending extrusion. An extruding temperature was set as 200° C., a rotating speed of the extruder was 100 r/min, and feeding rate was 5 Hz. After granulation, the obtained product was dried at 90° C. for 60 minutes to obtain the polypropylene material.

Properties of the polypropylene material are shown in Table 1.

### EXAMPLE 10

(1) Preparation of Polypropylene Modifier

97.2 parts of dimethylaminoethyl methacrylate grafted polypropylene were weighed, and fully mixed with 2.8 parts of diethylene triamine. The fully mixed raw materials were added into a HAAKE double-screw extruder, wherein an extruding temperature was set as 210° C., a rotating speed of the extruder was 50 r/min, and feeding rate was 3 Hz. After extrusion granulation, the obtained product was dried at 90° C. for 120 minutes to obtain an amine-modified polypropylene.

(2) Preparation of Polypropylene Material

10 parts of the polypropylene modifier and 90 parts of polypropylene L5E89 were evenly mixed, and then added into a HAAKE double-screw extruder for blending extrusion. An extruding temperature was set as 200° C., a rotating speed of the extruder was 100 r/min, and feeding rate was 5 Hz. After granulation, the obtained product was dried at 90° C.′ for 120 minutes to obtain the polypropylene material.

Properties of the polypropylene material are shown in Table 1.

### COMPARATIVE EXAMPLE 4

A polypropylene modifier and a polypropylene material were prepared according to the methods in Example 10 except that, during preparation of the polypropylene modifier, the dimethylaminoethyl methacrylate grafted polypropylene was replaced by the acrylic acid grafted polypropylene in an equal mass.

Properties of the prepared polypropylene material are shown in Table 1.

### EXAMPLE 11

(1) Preparation of Polypropylene Modifier

99.2 parts of acrylamide grafted polypropylene were weighed, and fully mixed with 0.8 part of 3,3′,4,4′-tetraaminodiphenyl ether. The fully mixed raw materials were added into a HAAKE double-screw extruder, wherein an extruding temperature was set as 210° C., a rotating speed of the extruder was 50 r/min, and feeding rate was 3 Hz. After extrusion granulation, an obtained product was dried at 90° C. for 120 minutes to obtain an amine-modified polypropylene.

(2) Preparation of Polypropylene Material

10 parts of the polypropylene modifier and 90 parts of polypropylene L5E89 were evenly mixed, and then added into a HAAKE double-screw extruder for blending extrusion. An extruding temperature was set as 200° C., a rotating speed of the extruder was 100 r/min, and feeding rate was 5 Hz. After granulation, the obtained product was dried at 90° C. for 120 minutes to obtain the polypropylene material.

Properties of the polypropylene material are shown in Table 1.

### EXAMPLE 12

A polypropylene modifier and a polypropylene material were prepared according to the methods in Example 11 except that, during preparation of the polypropylene modifier, the acrylamide grafted polypropylene was replaced by the trimeric acrylic isocyanurate grafted polypropylene.

Properties of the prepared polypropylene material are respectively shown in Table 1.

### EXAMPLE 13

A polypropylene modifier and a polypropylene material were prepared according to the methods in Example 11 except that, during preparation of the polypropylene modifier, the content of the acrylamide grafted polypropylene and the 3,3′,4,4′-tetraaminodiphenyl ether were respectively adjusted to be 99.7 parts and 0.3 part.

Properties of the prepared polypropylene material are respectively shown in Table 1.

### COMPARATIVE EXAMPLE 5

10 parts of PE100 were weighed and evenly mixed with 90 parts of polypropylene L5E89, and then added into a HAAKE double-screw extruder for blending extrusion. An extruding temperature was set as 200° C., a rotating speed of the extruder was 100 r/min, and a feeding rate was 5 Hz. After granulation, the obtained product was dried at 90° C. for 60 minutes to obtain the polypropylene material.

Properties of the polypropylene material are shown in Table 1.

### COMPARATIVE EXAMPLE 6

10 parts of polypropylene WB130 were weighed and evenly mixed with 90 parts of polypropylene L5E89, and then added into a HAAKE, double-screw extruder for blending extrusion. An extruding temperature was set as 200° C., a rotating speed of the extruder was 100 r/min, and feeding rate was 5 Hz. After granulation, the obtained product was dried at 90° C. for 60 minutes to obtain the polypropylene material.

Properties of the polypropylene material are shown in Table 1.

TABLE 1

| | Melt | Tensile | Bending | Bending |
|---|---|---|---|---|
| | strength | strength | strength | modulus |
| Sample | (cN) | (MPa) | (MPa) | (MPa) |
| L5E89 | 8.6 | 3.41 | 41.1 | 1552.5 |
| Example 1 | 23.8 | 3.93 | 44.5 | 1822.6 |
| Comparative Example 1 | 20.6 | 3.28 | 38.2 | 1485.2 |
| Example 2 | 21.9 | 3.82 | 43.5 | 1753.2 |
| Example 3 | 24.1 | 3.99 | 44.8 | 1854.3 |
| Example 4 | 21.6 | 4.02 | 42.9 | 1702.8 |
| Example 5 | 22.3 | 3.95 | 43.0 | 1743.9 |
| Example 6 | 23.8 | 4.02 | 45.6 | 1868.9 |
| Example 7 | 20.7 | 3.62 | 42.1 | 1693.8 |
| Example 8 | 22.9 | 3.91 | 43.5 | 1769.2 |
| Comparative Example 2 | 13.6 | 3.15 | 36.9 | 1366.9 |
| Comparative Example 3 | 22.6 | 3.29 | 37.5 | 1406.7 |
| Example 9 | 23.0 | 4.05 | 46.1 | 1899.2 |
| Example 10 | 24.2 | 4.21 | 46.2 | 1929.3 |
| Comparative Example 4 | 12.9 | 3.05 | 35.9 | 1389.3 |
| Example 11 | 24.9 | 3.92 | 43.7 | 1793.8 |
| Example 12 | 24.5 | 3.78 | 42.5 | 1755.9 |
| Example 13 | 20.1 | 3.66 | 42.3 | 1710.8 |
| Comparative Example 5 | 12.4 | 2.98 | 32.1 | 1278.2 |
| Comparative Example 6 | 14.6 | 3.29 | 37.1 | 1400.5 |

It can be seen from Table 1 that, the melt strength of the ordinary linear polypropylene L5E89 is 8.6 cN. In Examples 1 to 13, after adding the polypropylene modifier of the present invention, the melt strength of the products is improved, and the mechanical properties such as tension property and bending property of the polypropylene material are improved. In Comparative Examples 2 and 4, although the melt strength is improved, the melt strength is obviously lower than the melt strength of the polypropylene material modified by the polypropylene modifier of the present invention. Comparative Examples I to 4 all lead to reduction of the mechanical properties of the linear polypropylene. Therefore, the polypropylene modifier provided by the present invention can obviously improve the melt strength and the mechanical properties of the polypropylene, thus broadening the application field.

Those described above are preferred embodiments of the present invention, but are not intended to limit the present invention. Within the scope of the technical concept of the present invention, many simple modifications can be made to the technical solutions of the present invention, comprising the combination of various technical features in any other suitable way. These simple modifications and combinations shall also be regarded as the contents disclosed by the present invention and belong to the protection scope of the present invention.

1. A preparation method for a polypropylene modifier, comprising:
bringing a polar monomer grafted polypropylene into contact with a component A in formula (1) or formula (2) to carry out reactive extrusion and granulation, and then carrying out drying, wherein a polar monomer in the polar monomer grafted polypropylene is capable of chemically reacting with the component A;
in formula (1), the polar monomer is at least one selected from maleic anhydride, acrylic acid, acrylate, methacrylic acid, methacrylate, vinyl neodecanoate, glycidyl methacylate, dimethylaminoethyl methacrylate, epoxy acrylate, trimeric acrylic isocyanurate, and acrylamide; and the component A is at least one selected from polyisocyanate and polyethylene oxide;
in formula (2), the polar monomer is at least one selected from dimethylaminoethyl methacrylate, epoxy acrylate, trimeric acrylic isocyanurate, and acrylamide; and the component A is at least one selected from polyisocyanate, polyethylene oxide, and an amine-containing substance, wherein the amine-containing substance is at least one selected from a compound I and a compound II, the compound I is an organic substance comprising an amine group, an ether bond, and an aryl group, and the compound II is polyamine; and
based on a total weight of the polar monomer grafted polypropylene and the component A in each formula, a content of the polar monomer grafted polypropylene ranges from 95 wt % to 99.8 wt %, and a content of the component A ranges from 0.2 wt % to 5 wt %.

2. The preparation method according to claim 1, wherein the polyisocyanate is one or more selected from diphenylmethane diisocyanate, 2,4-tolylene diisocyanate, 2,6-tolylene diisocyanate, p-phenylene diisocyanate, hexamethylene diisocyanate, and 4,4,4-triphenylmethane triisocyanate.

3. The preparation method according to claim 1, wherein a molecular weight of the polyethylene oxide ranges from 50×10⁴ g/mol to 200×10⁴ g/mol.

4. The preparation method according to claim 1, wherein the compound I is one or more selected from 4,4′-diaminodiphenyl ether, phenoxyaniline, 3,4′-diaminodiphenyl ether, and 3,3′,4,4′-tetraaminodiphenyl ether;
the compound II is one or more selected from alkyl diamine, alkylene diamine, alkylene triamine, alkylene tetramine, alkylene pentamine, and aryl diamine.

5. The preparation method according to claim 1, wherein based on the total weight of the polar monomer grafted polypropylene and the component A in each formula, the content of the polar monomer grafted polypropylene ranges from 97 wt % to 99.5 wt %, and the content of the component A ranges from 0.5 wt % to 3 wt %.

6. The preparation method according to claim 1, wherein the acrylate is at least one selected from ethyl acrylate, butyl acrylate, and 2-ethylhexyl acrylate; the methacrylate is at least one selected from ethyl methacrylate, propyl methacrylate, butyl methacrylate, and 2-hydroxyethyl methacrylate.

7. The preparation method according to claim 1, wherein the reactive extrusion is carried out at a temperature of 150° C. to 220° C.

8. A polypropylene modifier prepared by the preparation method according to claim 1.

9. A polypropylene composition comprising the polypropylene modifier according to claim 8 and polypropylene.

10. A preparation method for polypropylene material, comprising: blending the polypropylene modifier according to claim 8 and polypropylene at 180° C. to 220° C. to carry out extrusion granulation, and then carrying out drying.

11. A polypropylene material prepared by the preparation method according to claim 10.

12. The preparation method according to claim 4, wherein the compound II is one or more selected from C2-12 alkyl diamine, C2-12 alkylene diamine, C2-C12 alkylene triamine, C2-C12 alkylene tetramine, C2-C12 alkylene pentamine, and C6-C18 aryl diamine.

13. The preparation method according to claim 4, wherein the compound II is one or more selected from tetraethylene pentamine, triethylene diamine, diethylene triamine, triethylene tetramine, p-phenylenediamine, m-phenylenediamine, 1,9-diaminononane, and 1,12-diaminododecane.

14. The preparation method according to claim 6, wherein a grafting ratio of the polar monomer grafted polypropylene ranges from 0.1% to 3%.

15. The preparation method according to claim 6, wherein a grafting ratio of the polar monomer grafted polypropylene ranges from 0.5% to 2%.

16. The polypropylene composition according to claim 9, wherein based on a total weight of the polypropylene composition, a content of the polypropylene modifier ranges from 2% to 20%.

17. The polypropylene composition according to claim 9, wherein based on a total weight of the polypropylene composition, a content of the polypropylene modifier ranges from 5% to 10%.

18. The preparation method according to claim 10, wherein based on a total weight of the polypropylene modifier and the polypropylene, a content of the polypropylene modifier ranges from 2% to 20%.

19. The preparation method according to claim 10, wherein based on a total weight of the polypropylene modifier and the polypropylene, a content of the polypropylene ranges from 5% to 10%.
